(19) United States
(12) Patent Application Publication
(10) Pub. No.: US 2007/0159533 A1
(43) Pub. Date: Jul. 12, 2007

(54) Image filing method, digital camera, image filing program and video recording player

(75) Inventor: Kenichiro Ayaki, Saitama (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/640,224

(22) Filed: Dec. 18, 2006

(30) Foreign Application Priority Data
Dec. 22, 2005 (JP) 2005-370690

(51) Int. Cl. H04N 5/225

(52) U.S. Cl. 348/207.99

(57) ABSTRACT

The user of a digital camera inputs an event title before shooting, so images shot under the same event title are stored in a group of image files. A face image extractor extracts face images from the respective image files, and characteristic values of the face images are calculated. In each image file group, the characteristic values of one face image are compared with other's, to judge those face images having similar characteristic values to be the same person's. Among the face images extracted from the image files of the same group, one of the most frequently appearing person's face images is determined to be a representative image. Data of the representative image is stored in association with the corresponding image file group, so the representative image and the event title may be displayed as an index to that image file group.

### FIELD OF THE INVENTION

The present invention relates to an image filing method for filing plural sets of image data, a digital camera having an image filing function, an image filing program for an imaging device or a computer, and a video recording player having an image filing function.

### BACKGROUND OF THE INVENTION

Image signals captured by an imaging device such as a CCD image sensor are processed into digital image data, and the image data is stored in a storage medium such as a memory card. It has recently been popular to store or record not only image data of still images but also moving or video images as digital image data in a large capacity storage medium like a DVD. For the sake of user's convenience on reproducing or editing the recorded images, or transferring the stored image data to some external apparatus or another storage medium, the image data of a plurality of images are mostly organized into files as they are written in the storage medium.

For example, Japanese Laid-open Patent Application No. 2005-174308 discloses a digital media organizing method based on face recognition, wherein facial images are detected from image data of a number of digital photographs, to sort and organize the digital photographs (the image data) based on the detected facial images.

Meanwhile, as the most practical and convenient filing method for the image data, it has been suggested, for example in Japanese Laid-open Patent Application Nos. 2002-216104 and Hei 10-40063, that data of a shot scene, including the classification of the scene, such as a tour name or an event name, and the date of the scene, is attached to the image data, so that the image data are grouped into image files according to the attached data.

The above-mentioned Japanese Laid-open Patent Application No. 2002-216104 discloses a computer software program, whereby image data captured under different conditions for a certain time period are sorted and filed according to a predetermined standard. For example, the image data are grouped into those categories which are selected from among predetermined categories, or based on those categories customized by the user.

The above-mentioned Japanese Laid-open Patent Application No. Hei 10-40063 discloses an image data processing method and an apparatus for this method, wherein a file system having a hierarchical tree structure allocates one image to one file, and allocates one directory name to one group of image data. On executing image-processing or the like using this file system, compressed images, called thumbnails, are displayed to indicate image data of those files which belong to a designated directory and/or image data of one file which belongs to another directory that belongs to the designated directory, i.e. the directory categorized under the designated directory.

According to the latter two prior arts, however, it is not easy for the user to recognize how the images are grouped and filed, so it is difficult for the user to find out an expected image among the files. The user cannot always be reminded of the content of the event just by the allocated event name. Although the third prior art displays one thumbnail to each individual image file, the thumbnail indicates only one image data, e.g. initially stored image data, among all image data stored in the image file. Just one thumbnail is not always enough to grasp the content of the image file. Indeed the first mentioned prior art extracts facial images from the respective image data, it is impossible to recognize the content of the event from the extracted facial image, because the image data is categorized according to the event name or the like, under the classification based on the facial image.

### SUMMARY OF THE INVENTION

In view of the foregoing, a primary object of the present invention is to provide an image filing method, a digital camera, an image filing program and a video recording player, which make it easy for the user to recognize the content of a group or set of stored image data, and thus improves user's convenience and saves time and labor for the choice of the image data.

According to the present invention, in a digital camera comprises an imaging optical system for forming an optical image of a subject, an imaging device for converting the optical image into an electronic picture signal, a signal processor for processing the picture signal to produce digital image data, and a data writing device for writing the image data of one image as an image file on a storage medium so that a plurality of image files are stored in groups in the storage medium, the digital camera comprises:

a device for extracting face images from the image data;

a device for calculating characteristic values of the extracted face images;

a device for comparing the characteristic values of the face images within the same group of image files, to judge those face images having similar characteristic values to each other to be the same person's; and

a device for deciding a representative image for each image file group, wherein one of the most frequently appearing person's face images is determined to be the representative image among the face images of the same image file group, and data of the representative image is stored in association with the corresponding image file group.

Preferably, the digital camera further comprises a display device for displaying images reproduced from the stored data, and an operating device for choosing one from among the image file groups on a menu screen of the display device, wherein the menu screen displays the representative images as options corresponding to the respective image file groups.

According to the present invention, an image filing method for storing image data as image files while grouping them into given categories, such as event titles, comprises steps of:

extracting face images from the image data;

calculating characteristic values of the extracted face images;

comparing the characteristic values of the face images within the same group of image files, to judge those face images having similar characteristic values to each other to be the same person's;

deciding a representative image for each image file group, wherein one of the most frequently appearing person's face images is determined to be the representative image among the face images of the same image file group; and

storing data of the representative image in association with the corresponding image file group.

An image filing program of the present invention for an imaging apparatus that captures images at some events and stores image data of the captured images as image files in a storage medium while grouping the image files according to the events, makes the imaging apparatus execute the following processes of:

extracting face images from the image data;

calculating characteristic values of the extracted face images;

comparing the characteristic values of the face images within the same group of image files, to judge those face images having similar characteristic values to each other to be the same person's;

deciding a representative image for each image file group, wherein one of the most frequently appearing person's face images is determined to be the representative image among the face images of the same image file group; and

storing data of the representative image in association with the corresponding image file group in the storage medium.

The image filing program of the present invention is applicable to a computer.

The present invention is also provides a video recording player that obtains moving image data, writes the moving image data in a storage medium, and plays moving images while reading the moving image data from the storage medium, the moving image recording playing apparatus comprising:

a device for extracting face images from a series of image frames constituting a set of moving image data;

a device for calculating characteristic values of the extracted face images;

a device for comparing the characteristic values of the face images within the same set of moving image data, to judge those face images having similar characteristic values to each other to be the same person's;

a device for deciding a representative image for each set of moving image data, wherein one of the most frequently appearing person's face images is determined to be the representative image among the face images of the same set of moving image data; and

a device for storing data of the representative image in the storage medium in association with the corresponding set of moving image data.

According to the present invention, an image filing method for filing plural sets of moving image data comprises steps of:

extracting face images from a series of image frames constituting a set of moving image data;

calculating characteristic values of the extracted face images;

comparing the characteristic values of the face images within the same set of moving image data, to judge those face images having similar characteristic values to each other to be the same person's;

deciding one of the most frequently appearing person's face images is determined to be a representative image among the face images of the same set of moving image data; and

storing data of the representative image in association with the corresponding set of moving image data.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a front perspective view of a digital camera according to a first embodiment of the present invention;

FIG. 2 is a rear perspective view of the digital camera according to the first embodiment of the present invention;

FIG. 3 is a block diagram schematically illustrating internal structure of the digital camera according to the first embodiment of the present invention;

FIG. 4 is an explanatory diagram illustrating characteristic values to calculate from face images;

FIG. 5 is a graph illustrating a distribution map of the characteristic values calculated from face images;

FIG. 6 is an explanatory diagram illustrating a directory structure for storing image files in groups and representative images of the respective groups;

FIG. 7 is a flow chart illustrating a sequence of shooting and image-filing processes;

FIG. 8 is an explanatory diagram illustrating an event title input screen and a viewfinder screen with an inputted event title;

FIG. 9 is a flow chart illustrating a sequence of reproducing recorded images;

FIG. 10 is an explanatory diagram illustrating examples of screens for image reproduction;

FIG. 11 is a block diagram schematically illustrating internal structure of an image filing apparatus according to a second embodiment of the present invention;

FIG. 12 is a block diagram schematically illustrating internal structure of a video recording player according to a third embodiment of the present invention;

FIG. 13 is a flow chart illustrating a sequence of recording and filing a television program as moving image data in the third embodiment;

FIG. 14 is an explanatory diagram illustrating a directory structure for storing the moving image data in program files and representative images of the respective program files;

FIG. 15 is a flow chart illustrating a sequence of playing the recorded program; and

FIG. 16 is an explanatory diagram illustrating examples of screens for playing the recorded program.

### DESCRIPTION OF THE PREFERRED EMBODIMENTS

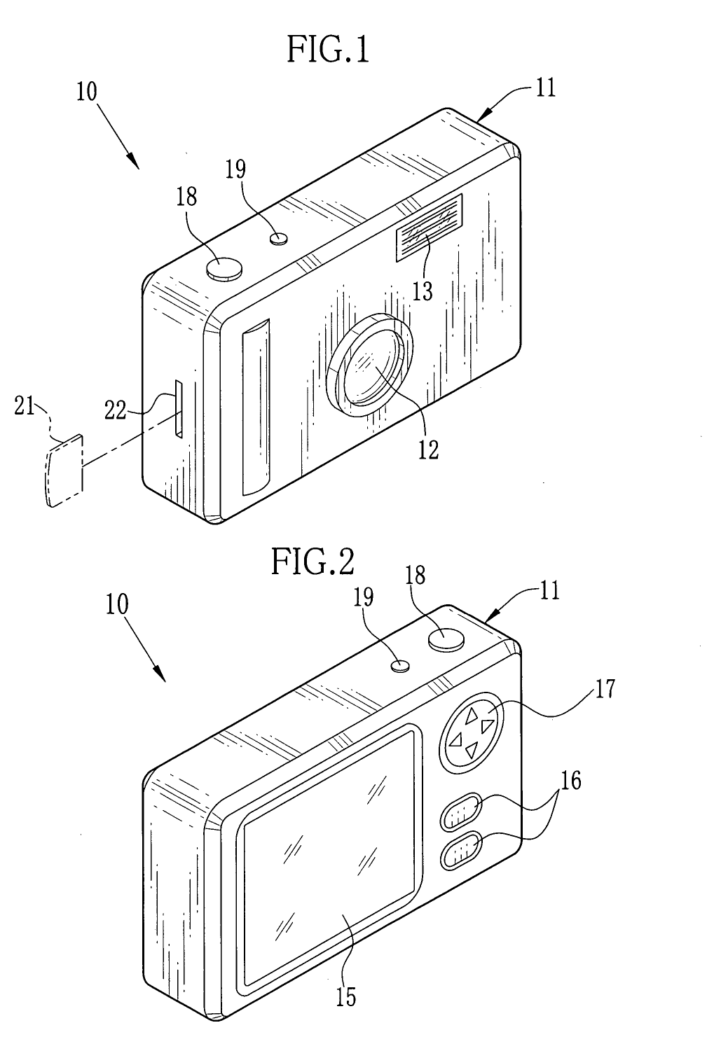

As shown in FIGS. 1 and 2, a digital camera 10 to which the present invention is applied is provided with a taking lens 12 and a flash projector 13 on the front of a camera body 11 of an approximately rectangular solid. On the back of the camera body 11, there are a LCD 15 for displaying an image, operating buttons 16 for executing “ENTER” and “CANCEL” and a cursor button 17. Moreover, the top of the camera body 11 is provided with a release button 18 and a power button 19, and the right side of the camera body 11 has a slot 22 into which a memory card 21 for storing image data is removably loaded.

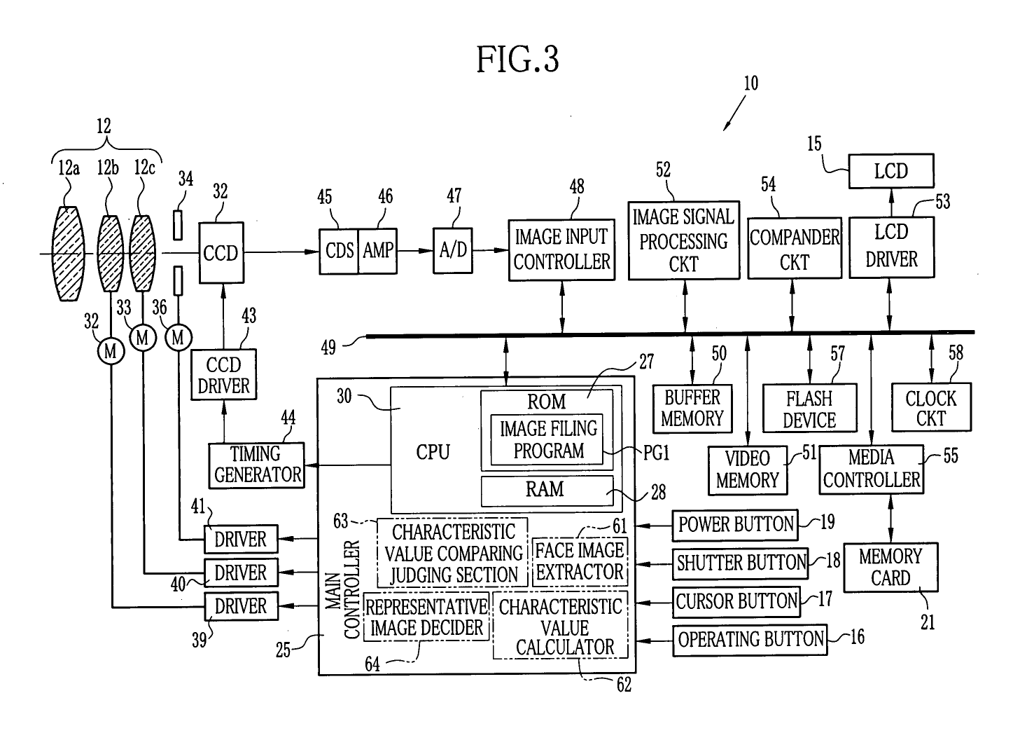

Next, the electrical composition of the digital camera 10 will be explained. As shown in FIG. 3, the digital camera 10 is provided with a main controller 25 for controlling overall operation of respective components of the digital camera 10. The main controller 25, whose main component part is a CPU 30, controls shooting, recording, reproducing, deletion and transferring of the image based on various control programs. The CPU 30 is provided with a ROM 27 and a RAM 28 as storage devices. The ROM 27 stores an after-mentioned image filing program PG1 as well as the various control programs and various data for control. The RAM 28 temporally stores working data.

At the rear of the taking lens 12, a CCD image sensor 31 that is an imaging device for converting an optical image of a subject produced by the taking lens 12 into an electronic image is arranged. The taking lens 12 consists of a fixed lens 12a, a zoom lens 12b and a focus lens 12c. The zoom lens 12b and the focus lens 12c are moved by a zoom drive motor 32 and a focus drive motor 33 respectively. In front of the CCD image sensor 31, a stop mechanism 34 is placed. The stop mechanism 34 changes f-number (aperture value) by a stop drive motor 36. The zoom drive motor 32, the focus drive motor 33 and the stop drive motor 36 are connected to drivers 39, 40 and 41 respectively and their drive are controlled by the main controller 25 via the drivers 39, 40 and 41.

The CCD image sensor 31 is connected to a CCD driver 43 that drives the CCD image sensor 31 by inputting vertical and horizontal drive signals according to clock pulses inputted from a timing generator 44. Since the timing generator 44 is connected to the CPU 30, the main controller 25 controls the CCD image sensor 31 by controlling the timing generator 44 and emitting the clock pulses. The CCD image sensor 31 is also connected to a correlated double sampling circuit (CDS) 45 and an amplifier (AMP) 46, both of which remove noise and amplify an analog image signal outputted from the CCD image sensor 31. The analog image signal after noise removal and amplification is converted into digital image data by an A/D converter 47 and then outputted to an image input controller 48.

Connected to the CPU 30 via a data bus 49, the image input controller 48 is controlled by the main controller 25. The image input controller 48 is also connected to a buffer memory 50 and a video memory 51. The main controller 25 controls the image input controller 48 to make the image data stored in the buffer memory 50 and the video memory 51. Connected to an image signal processing circuit 52 via the data bus 49, the CPU 30 carries out such various image processing as gradation conversion, white balance correction and γ correction and YC conversion processing to the image data while the high-resolution image data is temporarily stored in the buffer memory 50.

When displaying the image on the LCD 15, low-resolution image data is temporarily stored in the video memory 51 and the image signal processing circuit 52 carries out simple image processing and simple YC conversion processing. The image data stored in the video memory 51 is sent to an LCD driver 53 via the data bus 49. The LCD driver 53 drives the LCD 15 to display the image after performing signal processing to the image data.

Via the data bus 49, the CPU 30 is connected to a compander circuit 54 and a media controller 55 (data writing device). The compander circuit 54 compresses the image data stored in the buffer memory 50, using such a compressing format as JPEG. The main controller 25 controls the media controller 55 to write the compressed image data and after-mentioned management data in the memory card 21. In addition, the compander circuit 54 expands the compressed image data when reproducing the image data stored in the memory card 21.

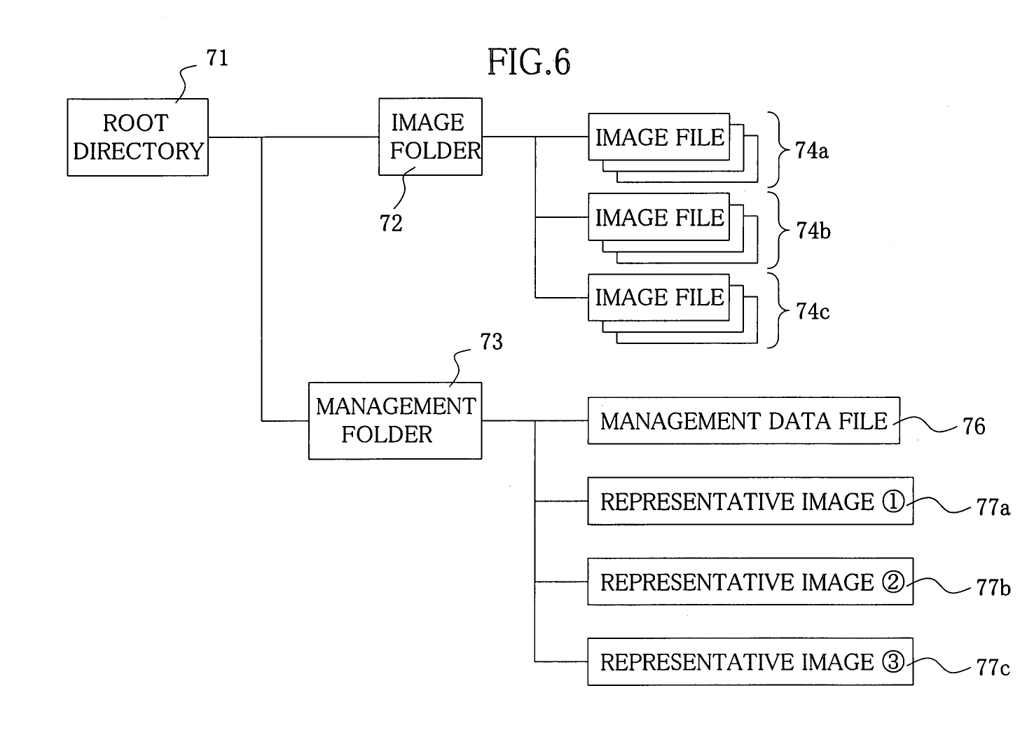

The CPU 30 is further connected to a flash device 57 and a clock circuit 58 via the data bus 49. The main controller 25 makes the flash projector 13 project flash light to the subject by controlling the flash device 57. Date data outputted by the clock circuit 58 is stored in a management data file 76 (See FIG. 6) together with an event title that is entered for each individual series of image files, as set forth later. Note that every captured image data is stored as an image file in the memory card 21, and a series of image data files which are stored under the same event title constitute a file group.

In the above described embodiment, the main controller 25 executes the image filing program PG1 to function as a face image extractor 61, a characteristic value calculator 62, a characteristic value comparing judging section 63 and a representative image decider 64.

The face image extractor 61 extracts face images from a plurality of image data files stored in the memory card 21. The face image extraction may be accomplished for example by pattern-matching against predetermined images of several patterns of faces or eyes.

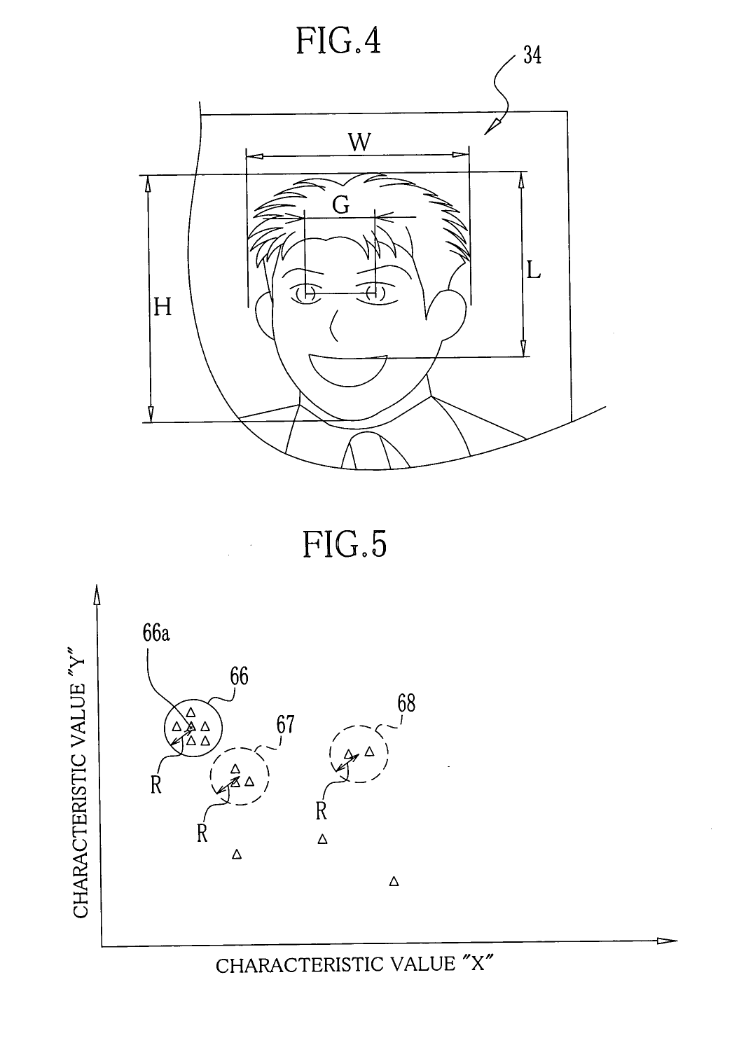

The characteristic value calculator 62 calculates characteristic values from each face image extracted in the face image extractor 61. As the characteristic values, anything that can convert characteristics of the face image into numerical values is usable. For example as shown in FIG. 4, a proportion (W/H) of a width (W) to a height (H) of a face image 65, a proportion (L/H) of a position of mouth (L) to the height (H) of the face image 65, a proportion (G/W) of a distance between eyes (G) to the width of the face image 65, a proportion of flesh color areas to black color (hair color) areas or a proportion of eye areas to the entire face area is usable.

FIG. 5 illustrates a map of distribution of the calculated characteristic values obtained from the plural face images. In the present embodiment, two characteristic values X and Y are calculated among of the above-mentioned characteristic values, and horizontal and vertical axes represent the characteristic values X and Y respectively.

The characteristic value comparing judging section 63 compares the characteristic values X and Y of the face images extracted from the same group of image files, to judge that those face images whose characteristic values X and Y are close to each other are the same person's face images. For example as shown in FIG. 5, as a way of discriminating the same person by approximation of the characteristic values X and Y, the face images whose characteristic values X and Y are within a kinship range of a predetermined radius R are judged to be the same person's, and are put into the same group. In FIG. 5, three groups surrounded by a solid line 66 and in dotted lines 67 and 68 are detected, which indicates that the face images of at least three persons are extracted.

The representative image decider 64 carries out a representative image deciding process. In this process, one of the most frequently appearing person's face images among those face images extracted from a group of image files is determined to be a representative image of the image file group. In an example of FIG. 5, because the face images in a group 66 surrounded by a solid line are the most frequent, the person who owns the face images in the group 66 is decided to be the representative. One of the face images in the group 66 becomes the representative image. For example, the face image which has the closest characteristic values X and Y to center values of the kinship range of this group 66, that is the characteristic values X and Y pointed with a mark 66a in FIG. 5, is chosen as the representative image.

The representative image decided by the representative image decider 64 is stored in the memory card 21, associated with the corresponding image file group. The representative image is stored in a file structure as shown in FIG. 6. A root directory 71 of the memory card 21 is provided with an image folder 72 and a management folder 73. In the image folder 72, image files grouped according to events, e.g. image file groups 74a, 74b and 74c, are stored. In the management folder 73, the management data file 76 and representative images 77a, 77b and 77c are stored. The representative images 77a, 77b and 77c correspond to the image file groups 74a, 74b and 74c respectively, and data of their association is written in the management data file 76. FIG. 6 illustrates three image file groups 74a, 74b and 74c, but the number of image file groups is not limited to three.

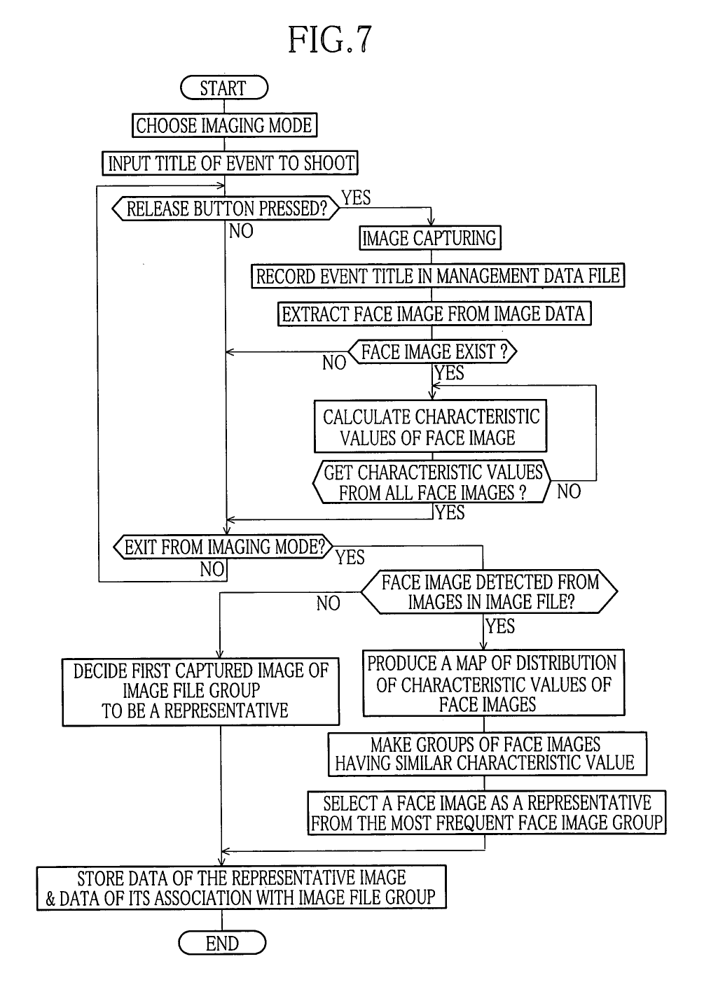

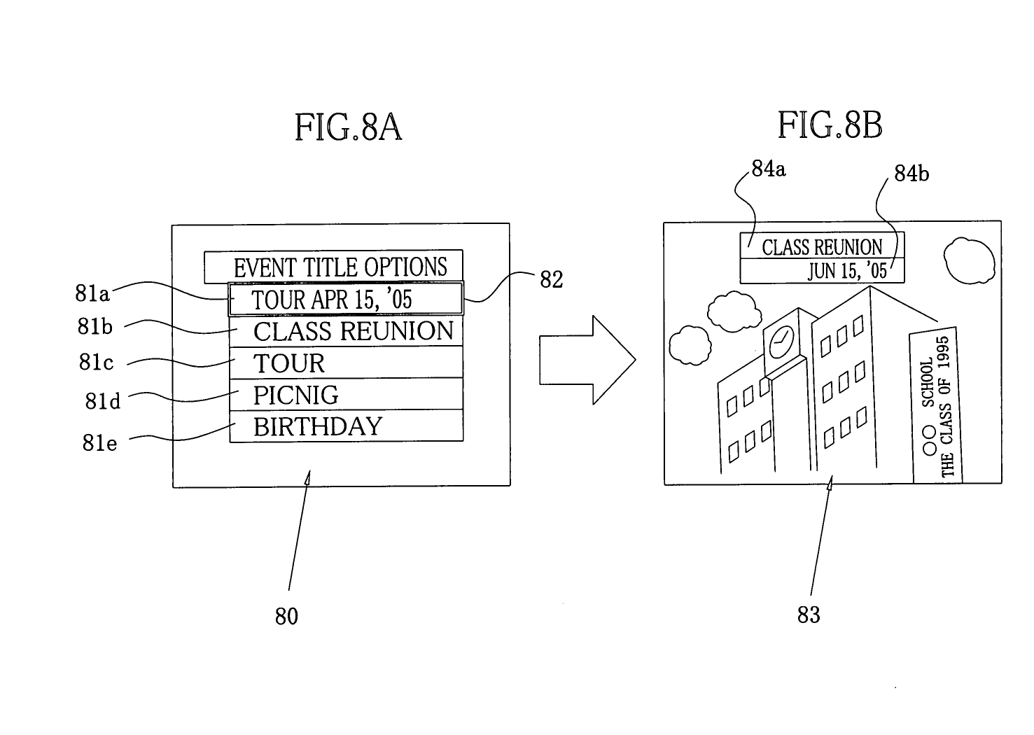

Now the operation of the above described embodiment will be explained while referring to a flowchart in FIG. 7. When the digital camera 10 is powered-on and an imaging mode is chosen for shooting, an event title input screen 80 is displayed as shown in FIG. 8A. In the event title input screen 80 are displayed an event title option 81a of “Tour Apr. 15, '05” that is the last inputted event title and other event title options 81b, 81c, 81d and 81e such as “Class Reunion,” “Tour,” “Picnic” and “Birthday”. On choosing the title of the event to shoot, one of the event titles chosen among the options 81a to 81e is surrounded by a bold-line frame 82, which moves by operating the cursor button 17 up and down. Instead of or in addition to the above described event title options, it is also possible to prepare more event title options and to display all of them with screen scrolling. Then the user chooses one of the event title options by operating the cursor button 17 and decides the choice by pressing the operating button 16.

At the conclusion of inputting the title event, the event title input screen 80 switches into a viewfinder screen 83 as shown in FIG. 8B. In the viewfinder screen 83 are displayed camera-through images and the event title 84a as inputted on the event title input screen 80. As a date 84b outputted from the clock circuit 58 at the input of the event title 84a has been stored in the management data file 76, the date 84b is displayed with the event title 84a. The user shoots an image by pressing the release button 18 while looking at the LCD 15 as a viewfinder. After the shooting, the captured image data is stored in the memory card 21. When a different event title is inputted prior to another shooting, the captured image data and the different event title are stored in the memory card 21. The image data captured at one shot is stored as an image file, and the image files are grouped according to the respective event titles, to form the image file groups.

After image capturing, the image files are put into a group under the input event title, and then the main controller 25 causes the face image extractor 61 to extract face images from the respective image data in the above described way. The characteristic value calculator 62 calculates from the extracted face image data the characteristic values X and Y, both of which are then written in the management data file 76. When the extraction of face images is done on all the image data of one image file group, the characteristic values X and Y are calculated from every frame image and written in the management data file 76. When no face image is extracted from the image data, data indicating that there is no face image is written in the management data file 76, instead of the above-mentioned characteristic values X and Y.

Next, when the digital camera 10 exits from the imaging mode, the main controller 25 judges whether or not any face images are extracted from the image files of the last captured group. When face images are extracted, the characteristic value comparing judging section 63 produces the map of distribution of the characteristic values X and Y to compare and judge as explained in FIG. 5. After grouping the face images of the same persons' from the comparison of the characteristic values X and Y, the representative image decider 64 decides a face image to be a representative, which has the closest characteristic values X and Y to the center values of the most frequent face image group. Then, of the entire image data containing the representative face image decided by the representative image decider 64, representative image data is cut out from a range including at least the representative face image, and is stored in the management folder 73. At the same time, data of associating the representative image data with the corresponding image file group is written in the management data file 76. When no face image is extracted from the image file, no comparison or judgment of the face image is executed. The image data captured first of the image file group is stored as the representative image in the management folder 73.

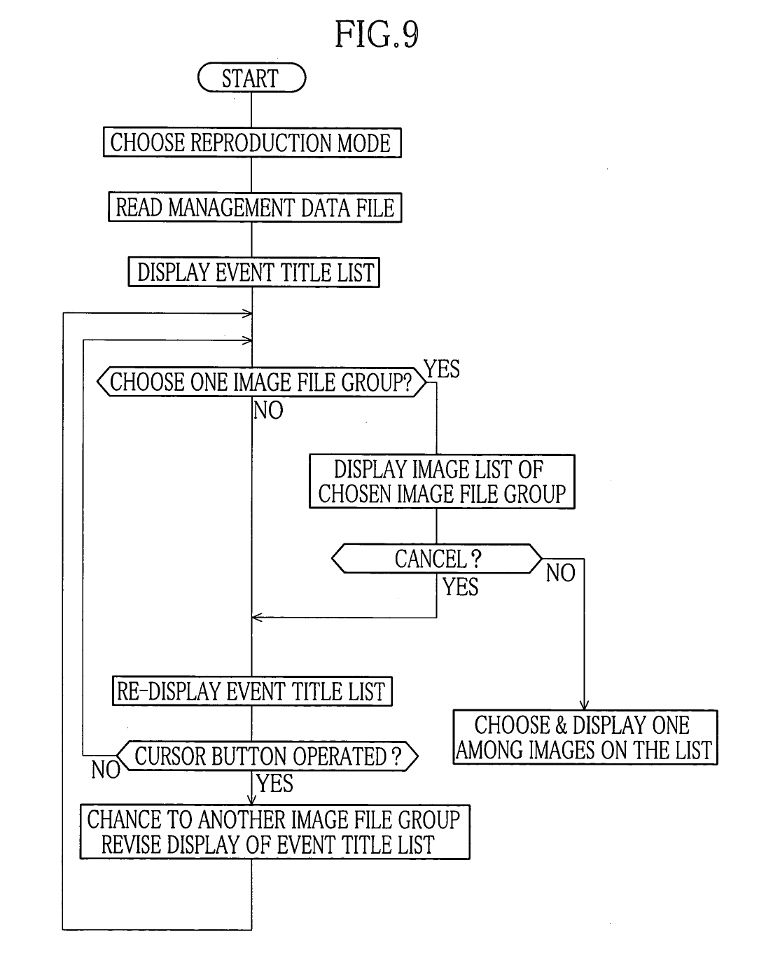

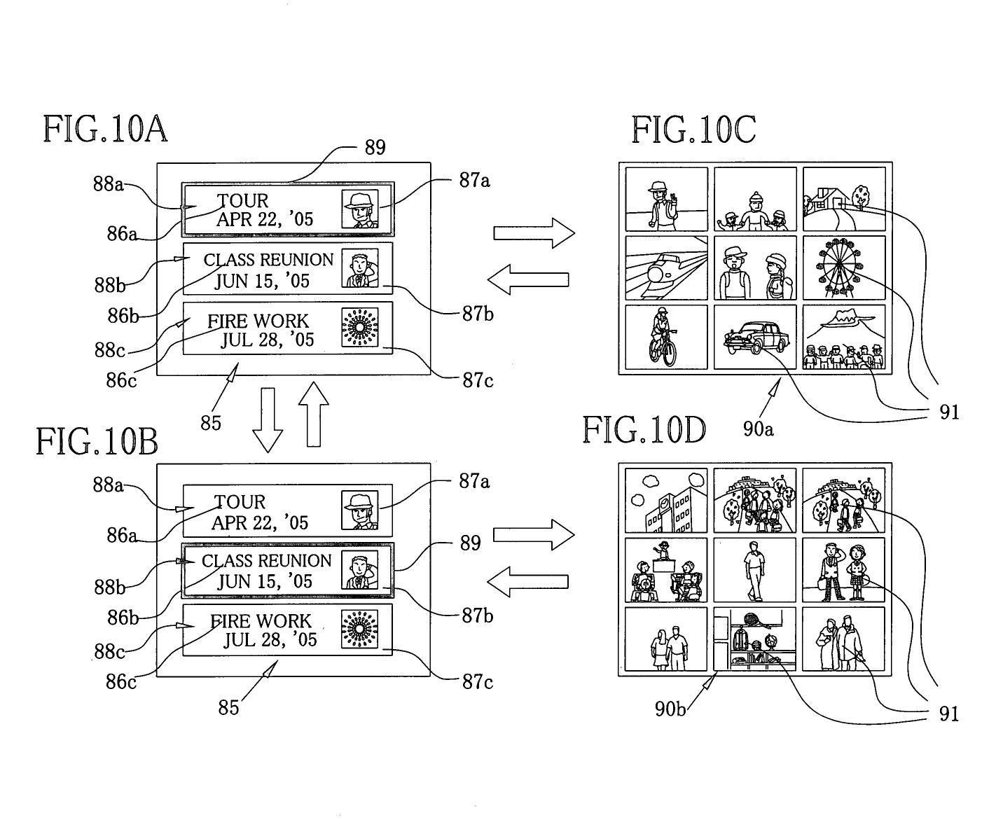

Now a sequence of reproducing the image file after the above described image filing processing will be explained while referring to a flowchart in FIG. 9. When a reproduction mode is chosen, the main controller 25 reads the management data file 76 from the memory card 21 and an event title list screen 85 as shown in FIG. 10A is displayed on the LCD 15. In the event title list screen 85, event menus 88a, 88b and 88c (within a rectangular frame for each) are displayed, each of which is a set of event title 86a, 86b or 86c representing an image file group and a corresponding representative image 87a, 87b or 87c respectively. The user chooses one of the event menus 88a, 88b and 88c by operating the cursor button 17. As shown in FIGS. 10A and 10B, the chosen one of the event menus 88a, 88b and 88c is surrounded by a bold-line frame 89, whose position changes up and down by operating the cursor button 17. Upon pressing the operating button 16 in the state that one of the event menus 88a, 88b and 88c is surrounded by the bold-line frame 89, the choice of the framed event menu is determined to be final.

When the user has chosen the appropriate image file group, the main controller 25 switches the LCD 15 from the event title list screen 85, as shown in FIG. 10A or 10B, to an image list screen 90a or 90b as shown in FIG. 10C or 10D. When the choice on the event title list screen 85 is determined in the cursor position shown in FIG. 10A, the image list screen 90a in FIG. 10C comes up. The image list screen 90b in FIG. 10D comes up when the choice on the event title list screen 85 is determined in the cursor position shown in FIG. 10B. On the image list screen 90a or 90b, the images contained in the chosen image file group are displayed as thumbnail images 91. While looking at the thumbnail images 91, the user chooses the image by operating the cursor button 17 and decides on the chosen image by pressing the operating button 16. The chosen image is then enlarged on the LCD 15.

When for example there is no appropriate image in the image list screen 90a shown in FIG. 10C during the choosing operation, the user may cancel the screen 90a to return to the event title list screen 85 as shown in FIG. 10A, where the image file group of the event menu 88a is chosen. Here the choice of another image file group is done again. When for example the image file of the event menu 88b is chosen and decided, the image list screen 90b shown in FIG. 10D is displayed.

Because the user is able to choose the image file group while looking at the representative image as well as the event title in this way, it is easy for the user to recognize the content of the image file group, which improves convenience and saves time and labor for the choice of the image file group.

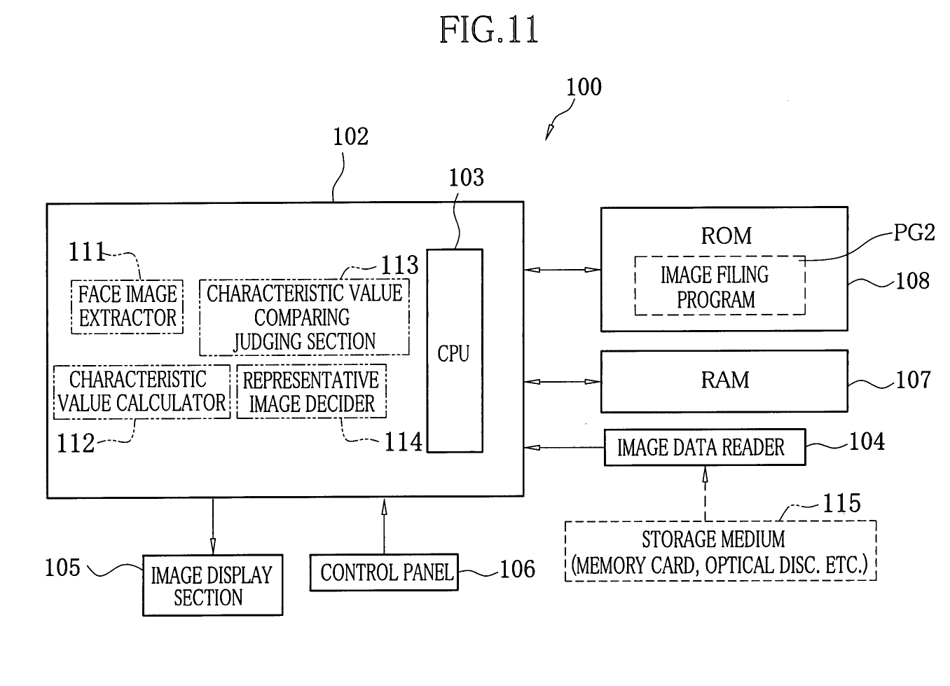

In the above described embodiment, the present invention is applied to the digital camera. However, the present invention is not limited to this application, but applicable to a personal computer or the like, which treats image data captured by an imaging device such as a digital camera and transferred to it. Now will be explained the second embodiment where the present invention is applied to a personal computer as an image filing device. As shown in FIG. 11, the personal computer 100, hereinafter referred to as PC, is provided with a main controller 102 whose main component part is a CPU 103. The CPU 103 is connected to an image data reader 104, an image display section 105 and a control panel 106. The image data reader 104 consists of a connector for reading image data from a storage medium such as memory card, and a disc drive for reading image data from an optical disc such as CD. The image display section 105 is provided with a liquid crystal display and the like and displays still images and others read as the image data. The control panel 106 detects user's input operation and sends the operation signals to the CPU 103.

In a ROM 108, an image filing program PG2 is stored. A RAM 107 temporarily stores the image data read by the image data reader 104. By executing the image filing program PG2, the main controller 102 functions as a face image extractor 111, a characteristic value calculator 112, a characteristic value comparing judging section 113 and a representative image decider 114.

Now the operation of the second embodiment will be explained. When a storage medium 115, such as memory card, optical disc or the like, is set in the image data reader 104 in a power-on state of the PC 100, the main controller 102 detects it and starts to read the image data of stored still images. The read image data is copied in the RAM 107. The image filing program PG2 may be set in a startup status before the image data reader 104 starts to read the image data, or may get into the startup status with the start of reading the image data. The main controller 102 carries out an image filing processing of the read image data. From then on, in the same way as the above described first embodiment, the face image extractor 111 extracts face images from the respective image data. Then the characteristic value calculator 112 calculates characteristic values. On all image data in a group of image files, extraction of face images and calculation of the characteristic values are executed.

Next, the characteristic value comparing judging section 113 of the main controller 102 produces a map of distribution of the characteristic values to compare them with one another. From the comparison of the characteristic values, those frame images having similar characteristic values are judged to be the same person's and put into a group. Then, the representative image decider 114 selects one face image out of the most frequent face image group to be a representative image. While representative image data based on the representative image is stored in the RAM 107, data of its association with the image file group is also stored in the RAM 107.

After deciding on the representative image, it is possible to display the representative image with an event title representing the associated image file group, or to write the association with the image file group in a management data file while storing the representative image in a management folder of the memory card 115. Because the representative image is stored with the event title while being associated with the image file group in this way, it is easy for a user to recognize the content at the image reproduction.

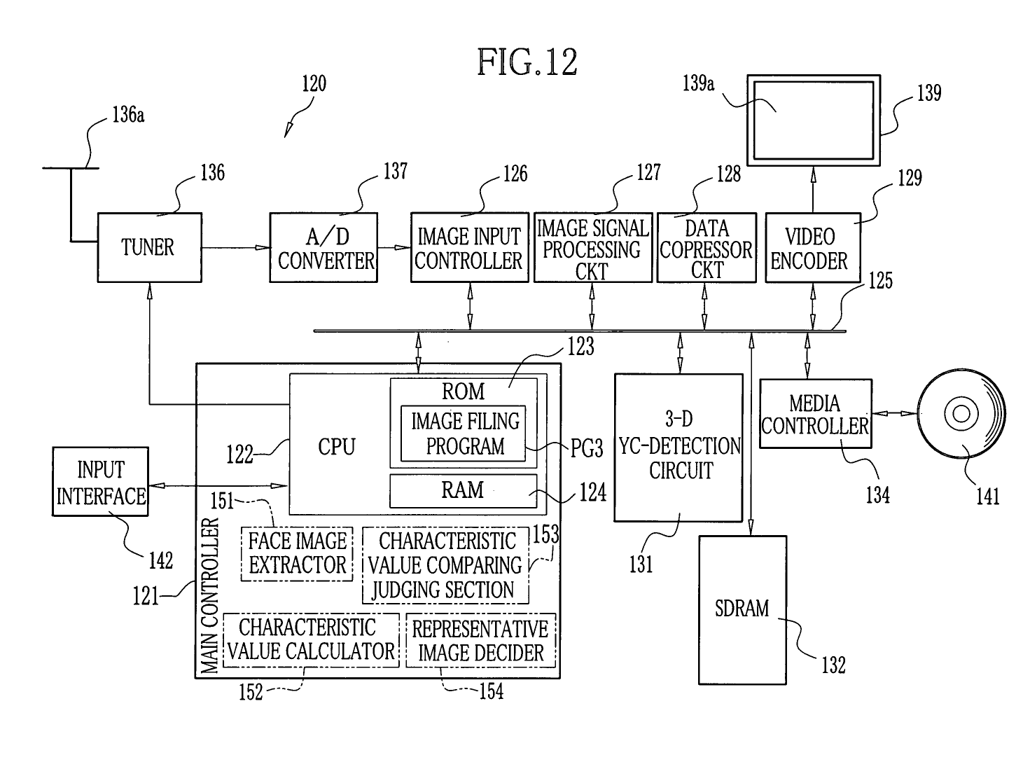

In the above described first and second embodiments, the present invention is applied to the imaging device including the digital camera that mainly captures and files image data of still images and the image filing device such as the PC. However, the present invention is not limited to these embodiments. Now will be described a third embodiment where the present invention is applied to a video recording player that records captured moving images and plays the moving images. FIG. 12 shows a DVD recorder 120 as the video recording player according to the third embodiment of the present invention. The DVD recorder 120 is provided with a main controller 121 for controlling overall operation of every part. The main controller 121 has a CPU 122 as the main component, and the CPU 122 includes a ROM 123 and a RAM 123. The main controller 121 executes an image filing program PG3 stored in the ROM 123. The CPU 122 is connected through a data bus 125 to an image input controller 126, an image signal processing circuit 127, a data compressor circuit 128, a video encoder 129, a 3-D YC-detection circuit 131, a SDRAM 132 and a media controller 134.

The DVD recorder 120 is further provided with a tuner 136 and an A/D converter 137 connected between the tuner 136 and the image input controller 126. The tuner 136 receives radio waves as telecast through an antenna 136a, converts the signals received according to the user's choice of broadcast station into picture signals, and sends the picture signal to the A/D converter 137, which converts the analog picture signals to digital moving image data, and sends it to the image input controller 126.

Connected to the CPU 122 via the data bus 125, the image input controller 126 is controlled by the main controller 121. The main controller 121 controls the image input controller 126 to store the moving image data in the SDRAM 132 temporarily.

The image signal processing circuit 127 carries out various image processing, such as gradation conversion, white balance correction and γ correction and YC conversion, to the moving image data temporarily stored in the SDRAM 132. The 3-D YC-detection circuit 131 carries out motion measurement from brightness signals and color signals, and reduces noise.

The video encoder 129 converts the moving image data, which goes through the signal processing in the image signal processing circuit 127 and the 3-D YC-detection circuit 131, or a data inputting menu screen into video signals, and sends the video signal to a monitor 139. As receiving the video signals, the monitor 139 displays the moving image or the menu screen on a display screen 139a.

The media controller 134 writes the moving image data after the signal processing on a DVD 141. An input interface 142 consisting of a remote controller and other elements detects user's input operation which is necessary for recording or playing the images, and sends the operation signals to the CPU 122.

The main controller 121 functions as a face image extractor 151, a characteristic value calculator 152, a characteristic value comparing judging section 153 and a representative image decider 154 by running the image filing program PG3.

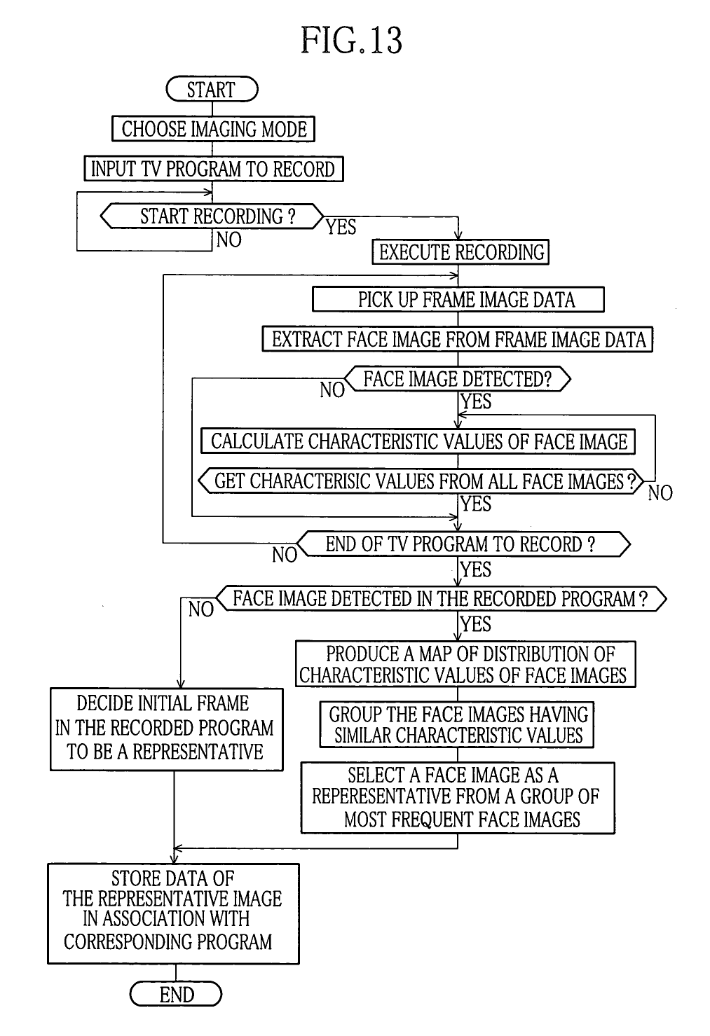

Now the operation of the image recording playing apparatus of the above described embodiment will be explained while referring to a flowchart in FIG. 13. After powering the DVD recorder 120 on, the user chooses a television program to record (a broadcast station, airtime and so on), and inputs a signal for starting image-recording through the input interface 142. Upon receipt of the input signal for recording, the CPU 122 obtains the picture signals from the broadcast station chosen by operating the tuner 136. The picture signals obtained through the tuner 136 are converted into digital signals in the A/D converter 137. Then, the digital signals go through the signal processing in the image signal processing circuit 127 and 3-D YC-detection circuit 131, to become the moving image data. After being temporarily written in the SDRAM 132, the moving image data of the television program to record is written in the DVD 141 with the corresponding program title by the media controller 134.

When the moving image data made of the picture signals received from the broadcast station is recorded in the DVD 141, the main controller 121 runs the image filing program PG3. The main controller 121 then picks up still image frames from the moving image data at a given interval of time. The face image extractor 151 extracts face image data from the extracted still image frames, and then the characteristic value calculator 152 calculates characteristic values from the face image data. Until the recording television program finishes, the extraction of all face images and the calculation of the characteristic values are executed to all still image frames extracted from the moving image data.

Next, when the recording television program finishes, the main controller 122 judges whether any face image is extracted from the recorded television program (moving image data) or not. When the face image is extracted, the characteristic value comparing judging section 153 produces a map of distribution of the characteristic values, so as to determine from comparison of the characteristic values which of the face images belong to the same person. Then the representative image decider 154 decides on the representative face image, which has the closest characteristic values to center values of the most frequent face image group. When the representative image is decided by the representative image decider 154, the still image frame including the representative face image is stored in a management folder. At the same time, data which associates the representative image data with the corresponding recorded television program (moving image data) is also written in a management data file. When no face image is extracted from the moving image data, the still image frame picked up first from the moving image file is stored as the representative image.

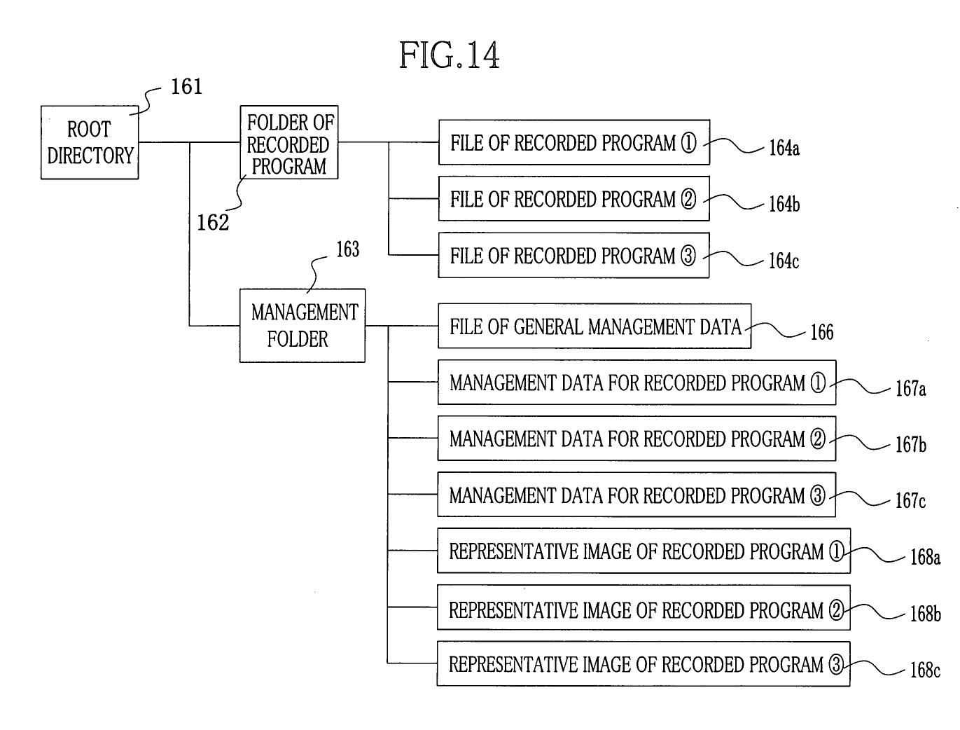

FIG. 14 illustrates the file composition of the moving image data and the representative image as stored in the DVD 141. A root directory 161 of the DVD 141 is provided with a folder of recorded program 162 where respective files of recorded programs (moving image data) 164a, 164b and 164c are stored, and with a management folder 163 where a file of general management data 166, management data files 167a, 167b and 167c for the respective recorded programs, and representative images 168a, 168b and 168c of the recorded program are stored. In the management data files 167a, 167b and 167c are respectively written data for associating the respective recorded program files 164a, 164b and 164c with the corresponding representative images 168a, 168b and 168c as well as data on the respective recorded program files 164a, 164b and 164c, including date, broadcast station and title of the program. The file of general management data 166 has data on locations in the DVD 141 where the respective recorded program files 164a, 164b and 164c are written.

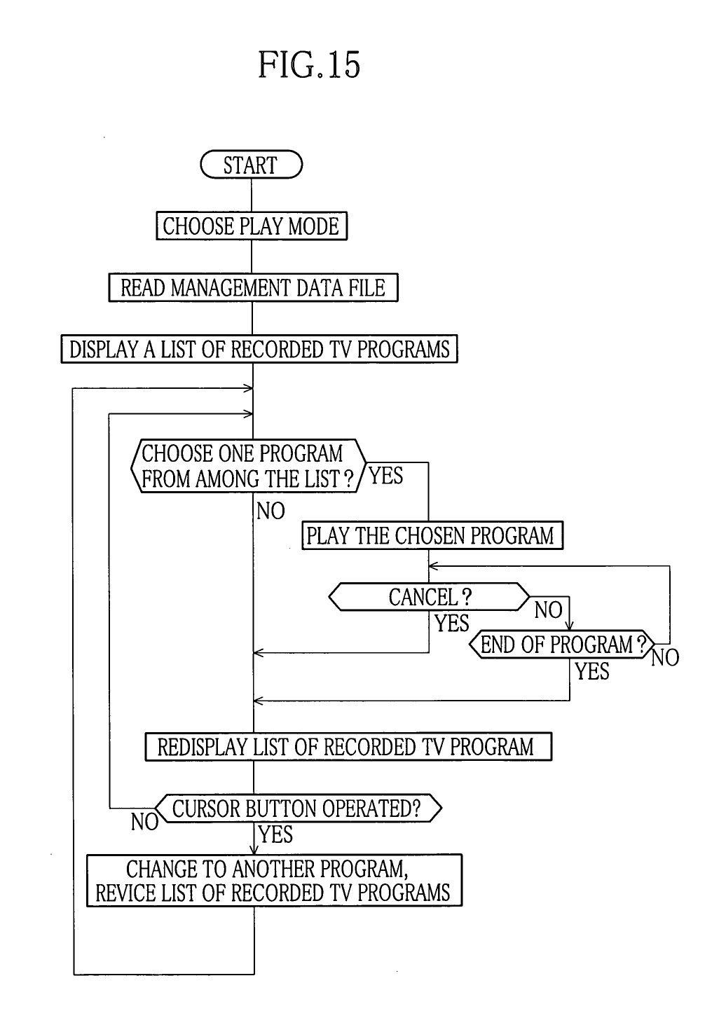

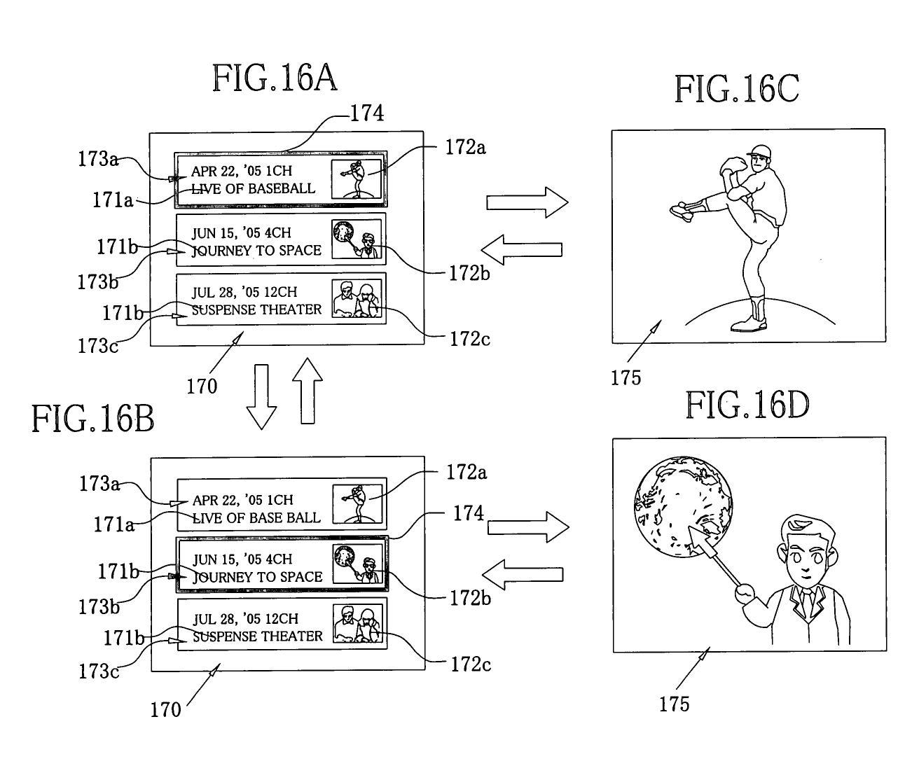

Now a sequence of reproducing the moving image data after the above-described image filing processing will be explained while referring to a flowchart in FIG. 15. When a play mode is chosen by operating the input interface 142, the main controller 121 reads the management data file 166, 167a, 167b and 167c from the DVD 141 and a recorded program title list screen 170 as shown in FIG. 16A is displayed on the monitor 139.

In the recorded program title list screen 170, recorded program menus 173a, 173b and 173c are displayed within a rectangular frame for each. Each of the recorded program menus 173a, 173b and 173c consists of a set of information 171a, 171b and 171c and the corresponding representative image 172a, 172b or 172c of the recorded program. The information includes date, broadcast station and program title, such as Live of Baseball, Journey to Space or Suspense Theater, of the recorded program.

A user chooses one of the recorded program menus by operating the input interface 142. During the choice, as shown in FIGS. 16A and 16B, an appropriate one of the recorded program menus 173a, 173b and 173c is surrounded by a bold-line frame 174 whose position changes up and down by operating for example a cursor button. The user decides on the choice by pressing an operating button in a state that one of the recorded program menus representing the intended recorded program is surrounded by the bold-line frame 174.

When the user chooses the appropriate one among the recorded program menus 173a, 173b and 173c on the recorded program title list screen 170, the main controller 121 reads the moving image data from the recorded program file 164a, 164b or 164c that corresponds to the chosen recorded program menu 173a, 173b or 173c, and switches the monitor 139 from the recorded program title list screen 170 as shown in FIGS. 16A and 16B, to a movie playing screen 180 as shown in FIGS. 16C and 16D, to start playing the recorded moving images. When all of the moving image data of the chosen program is reproduced, the recorded program title list screen 170 is redisplayed. During the choice of the recorded program menu, if the movie playing screen shown in FIG. 16C does not coincide with the intended program, the user makes a canceling operation to return to the recorded program title list screen 170 shown in FIG. 16A. And when another recorded program menu, for example the menu 173b, is chosen and decided on, as shown in FIG. 16B, another recorded program is played as shown in FIG. 16D.

Because the user is able to choose the recorded program while looking at the representative image in this way, it is easy for them to recognize the contents of the recorded program, which improves convenience and saves labor and time for the choice of the recorded program.

Although the present invention has been described with respect to the preferred embodiments, the present invention is not to be limited to the above embodiments but, on the contrary, various modifications will be possible without departing from the scope of claims appended hereto.

What is claimed is:

1. A digital camera comprising an imaging optical system for forming an optical image of a subject, an imaging device for converting the optical image into an electronic picture signal, a signal processor for processing the picture signal to produce digital image data, and a data writing device for writing the image data of one image as an image file on a storage medium, wherein a plurality of image files are stored in groups in said storage medium, and wherein said digital camera comprises:
a device for extracting face images from the image data;
a device for calculating characteristic values of the extracted face images;
a device for comparing the characteristic values of the face images within the same group of image files, to judge those face images having similar characteristic values to each other to be the same person's; and
a device for deciding a representative image for each image file group, wherein one of the most frequently appearing person's face images is determined to be the representative image among the face images of the same image file group, and data of the representative image is stored in association with the corresponding image file group.

2. A digital camera as claimed in claim 1, further comprising a display device for displaying images reproduced from the stored data, and an operating device for choosing one from among the image file groups on a menu screen of said display device, wherein said menu screen displays the representative images as options corresponding to the respective image file groups.

3. A digital camera as claimed in claim 2, wherein said display device displays a list of images contained in the chosen image file group when the choice on said menu screen is determined.

4. A digital camera as claimed in claim 2, further comprising a device for inputting a title of an event prior to shooting a series of images at the event, wherein said series of images is stored in an image file group with the input event title.

5. A digital camera as claimed in claim 4, wherein said display device displays the event title and the representative image for each image file group on said menu screen.

6. An image filing method for storing image data as image files while grouping them into given categories, said image filing method comprising steps of:
extracting face images from the image data;
calculating characteristic values of the extracted face images;
comparing the characteristic values of the face images within the same group of image files, to judge those face images having similar characteristic values to each other to be the same person's;
deciding a representative image for each image file group, wherein one of the most frequently appearing person's face images is determined to be the representative image among the face images of the same image file group; and
storing data of the representative image in association with the corresponding image file group.

7. An image filing method as claimed in claim 6, wherein said categories are given as event titles, one of which is chosen for each image file group.

8. An image filing program for an imaging apparatus that captures images at some events and stores image data of the captured images as image files in a storage medium while grouping the image files according to the events, said image filing program making said imaging apparatus execute the following processes of:
extracting face images from the image data;
calculating characteristic values of the extracted face images;
comparing the characteristic values of the face images within the same group of image files, to judge those face images having similar characteristic values to each other to be the same person's;
deciding a representative image for each image file group, wherein one of the most frequently appearing person's face images is determined to be the representative image among the face images of the same image file group; and
storing data of the representative image in association with the corresponding image file group in said storage medium.

9. An image filing program for a computer to execute an image filing process for storing image data captured at some events as image files in a storage medium while grouping the image files according to the events, said image filing program making said computer execute the following processes of:
extracting face images from the image data;
calculating characteristic values of the extracted face images;
comparing the characteristic values of the face images within the same group of image files, to judge those face images having similar characteristic values to each other to be the same person's;
deciding a representative image for each image file group, wherein one of the most frequently appearing person's face images is determined to be the representative image among the face images of the same image file group; and
storing data of the representative image in association with the corresponding image file group in said storage medium.

10. A video recording player that obtains moving image data, writes the moving image data in a storage medium, and plays moving images while reading the moving image data from said storage medium, said video recording player comprising:
a device for extracting face images from a series of image frames constituting a set of moving image data;
a device for calculating characteristic values of the extracted face images;
a device for comparing the characteristic values of the face images within the same set of moving image data, to judge those face images having similar characteristic values to each other to be the same person's;
a device for deciding a representative image for each set of moving image data, wherein one of the most frequently appearing person's face images is determined to be the representative image among the face images of the same set of moving image data; and
a device for storing data of the representative image in said storage medium in association with the corresponding set of moving image data.

11. A video recording player as claimed in claim 10, wherein said video recording player is connected to a monitor, and further comprises a device for displaying a menu screen on said monitor, said menu screen being used for choosing one from among plural sets of moving image data, and displaying the representative images as options corresponding to the respective sets of moving image data.

12. An image filing method for filing plural sets of moving image data, comprising steps of:
extracting face images from a series of image frames constituting a set of moving image data;
calculating characteristic values of the extracted face images;
comparing the characteristic values of the face images within the same set of moving image data, to judge those face images having similar characteristic values to each other to be the same person's;
deciding one of the most frequently appearing person's face images is determined to be a representative image among the face images of the same set of moving image data; and
storing data of the representative image in association with the corresponding set of moving image data.

13. An image filing program for a computer to execute an image filing process for storing plural sets of moving image data, said image filing program making said computer execute the following processes of:
extracting face images from a series of image frames constituting a set of moving image data;
calculating characteristic values of the extracted face images;
comparing the characteristic values of the face images within the same set of moving image data, to judge those face images having similar characteristic values to each other to be the same person's;
deciding one of the most frequently appearing person's face images to be a representative image among the face images of the same set of moving image data; and
storing data of the representative image in association with the corresponding set of moving image data.
